(19) United States
(12) Patent Application Publication
(10) Pub. No.: US 2025/0127102 A1
(43) Pub. Date: Apr. 24, 2025

(54) LANDSCAPING EDGE AND WEED BARRIER IRRIGATION SYSTEM

(71) Applicant: NISHI BROTHERS LLC, NEWBURY PARK, CA (US)

(72) Inventor: STEVEN NISHI, NEWBURY PARK, CA (US)

(21) Appl. No.: 18/919,604

(22) Filed: Oct. 18, 2024

Related U.S. Application Data
(60) Provisional application No. 63/660,332, filed on Jun. 14, 2024.
(60) Provisional application No. 63/544,843, filed on Oct. 19, 2023.

(51) Int. Cl. A01G 25/06; A01G 13/02

(52) U.S. Cl. CPC A01G 25/06; A01G 13/32

(57) ABSTRACT

Landscaping systems providing edging while also providing for improved water distribution, weed control and plant growth. One embodiment of a landscape edging and barrier irrigation system according to the present invention comprises a barrier strip having an integral edge tube capable of carrying a flow of water. A weed barrier is included comprising a barrier sheet with a barrier tube grid capable of carrying a flow of water. At least a portion of water flowing through the edge tube flows through the barrier tube grid, and the barrier tube grid comprises one or more grid openings to allow water to flow from the barrier tube grid.

This application claims the benefit of U.S. Provisional Patent Application Ser. No. 63/660,332, filed on Jun. 14, 2024, and U.S. Provisional Patent Application Ser. No. 63/544,843, filed on Oct. 19, 2023

### BACKGROUND OF THE INVENTION

### Field of the Invention

This invention relates to landscape irrigation, and in particular to an integrated landscaping edge and weed barrier irrigation system.

### Description of the Related Art

Landscaping can provide many different features and components beyond simply the plants. Landscape edging refers to the materials and structures used to create distinct boundaries between different areas within a landscape, such as between flower beds, lawns, pathways, and other elements. The primary purpose of landscape edging is to create clean and well-defined lines, preventing the encroachment of grass, mulch, or other materials into unwanted areas while also enhancing the visual appeal of the landscape.

Property owners are increasingly converting green grass lawns into water conservative gardens. Low maintenance is a critical aspect of modern gardening, direct watering and reduced weed growth helped preferred plants flourish decrease the need of chemical herbicides. Weed barrier materials have gained prominence as an environmentally friendly and sustainable solution to control weed proliferation while minimizing the need for chemical interventions.

Landscape edging plays a pivotal role in enhancing the aesthetics and functionality of outdoor spaces. This element serves as a boundary between different features of a landscape, such as flower beds, pathways, and lawns, providing a clear separation that adds visual appeal and order. Various materials are utilized to create edging that complements the overall design and theme of the landscape. Beyond its visual impact, landscape edging also offers practical benefits, including preventing the spread of grass into flower beds, containing mulch, and guiding foot traffic.

There are various types of landscape edging materials available, each with its own benefits and aesthetic qualities. One example is metal edging that can be made of aluminum, steel, or other metals. Metal edging provides a sleek and modern look, is durable and can create sharp angles and curves. Metal edging is often chosen for contemporary and formal garden designs. Another example is plastic edging that is affordable and easy to work with. It comes in various styles, including roll-style and strip-style edging. While not as durable as metal or stone, plastic edging is still effective for most residential landscaping projects. Natural stone or brick is often used that can create a rustic and timeless look. These materials are durable and can be arranged in various patterns to suit different landscape designs. Stone or brick edging might require more effort to install but can provide an elegant finish. Concrete edging offers a versatile option that can mimic the appearance of stone or brick. It is customizable and can be shaped to fit the desired layout and concrete edging can be stained or stamped for added visual interest. Wood edging provides a warm and natural look and is commonly used in informal garden designs and can be easily shaped and installed. Wood, however, is susceptible to decay over time, so it may require regular maintenance or replacement. Pavers can also be used and can be set vertically to create a solid and attractive boundary. They can be aligned with other hardscape elements like pathways or patios for a cohesive look. Rubber edging is a flexible and eco-friendly option that is relatively easy to install and can be shaped to form curves or straight lines.

Landscaping can also include different types of irrigation systems. For example, drip irrigation systems have long been used for efficient water distribution in agriculture and landscaping. Drip irrigation, also known as micro-irrigation or trickle irrigation, is a modern and efficient method of delivering water directly to the root zone of plants, thus minimizing water wastage and maximizing crop yield. This irrigation technique involves the controlled application of water through a network of tubes, pipes, and emitters that release water drop by drop, allowing for precise and targeted watering. In drip irrigation, the drip lines are semi-flexible tubes made of durable, UV-resistant material. They are designed to carry water from the main supply to the plants' root zones and the tubes are equipped with evenly spaced emitter nozzles, each containing a pressure-compensating mechanism to maintain consistent water flow rates regardless of pressure fluctuations in the system.

Traditional drip systems are currently placed over a weed barrier or placed over soil and an organic weed barrier (wood chips or rocks) can be placed over the irrigation system to hide the drip system. The drip lines can be buried under the soil or covered with mulch to minimize water evaporation. This additional step can result in over-irrigation, damage to the weed barrier and leading to water wastage, increased costs, and potential plant stress. These systems also do nothing to inhibit or prevent weed growth.

Traditional sprinkler systems involve digging a trench and burying piping, such as polyvinyl chloride (PVC) piping, throughout a yard. These traditional pipe systems can be complicated and costly to install and do not present the most efficient way to irrigate landscaping. At least some of the water emitted by these systems can miss the intended portion of the landscaping to be watered or can evaporate before hitting the intended landscaping. This can result in unnecessary waste of important water resources. Furthermore, these irrigation systems do nothing to inhibit or prevent weed growth.

Weed growth can cause significant challenges in maintaining desired plants, leading to reduced yield and increased labor Traditional costs. methods of weed management involve manual removal, herbicides, or mulching, each which has its drawbacks. Synthetic weed barriers that block weed grown have also been used and can comprise a durable and permeable material that inhibits weed growth while allowing for water and nutrient penetration to support desired plant growth. The barrier is suitable for various applications, including agriculture, landscaping, and gardening. Weed barrier materials are designed to impede weed growth by creating a physical barrier between the soil and the atmosphere. These materials can be synthetic or organic and are typically placed on the soil surface or within the upper soil layers. Synthetic options often include woven or non-woven fabrics made from materials like polypropylene, while organic alternatives involve materials such as mulches and decorative rock that can be placed on top of the synthetic weed barrier.

A need exists for an innovative solution that provides effective edging and weed control, while promoting efficient watering and healthy plant growth.

### SUMMARY OF THE INVENTION

The present invention is generally directed to landscaping systems providing the desired edging while also providing for improved water distribution, weed control and plant growth. Embodiments according to the present invention comprise interconnected edging and weed barriers having an integral irrigation system that provides flexible and efficient gardening or landscaping irrigation. In some embodiments, the systems can comprise drip irrigation features, and the edging and weed barriers can be modular which allows for interconnected portions to be included to match the shape and size of the gardening or landscaping. In still other embodiments, the integrated edging and irrigation system can be provided without a weed barrier, with the system still providing efficient gardening or landscape irrigation.

One embodiment of a landscape edging and barrier irrigation system according to the present invention comprises a barrier strip having an integral edge tube capable of carrying a flow of water. A weed barrier is comprising a barrier sheet with a barrier tube grid capable of carrying a flow of water. At least a portion of water flowing though the edge tube flows through the barrier tube grid, and the barrier tube grid comprises one or more grid openings to allow water to flow from the barrier tube grid.

Another landscape edging and barrier irrigation system according to the present invention comprises a barrier strip surrounding a landscaped area with the barrier strip capable of carrying a first flow of water down its length. A weed barrier is connected to the barrier strip and is arranged on said landscaped area. The weed barrier is capable of carrying a second flow of water and depositing at least some of said second flow of water on the landscaped area, wherein at least some of the second flow of water comprises at least a portion of said first flow of water.

The embodiments of irrigation systems according to the present invention represent a significant advancement in the field of irrigation planning, installation and maintenance. These systems ensure that plants receive the desired and proper amount of water, thereby minimizing waste and optimizing growth. These systems also provide for a reduction of weed growth and provide for design flexibility ease of expansion.

Different embodiments of the systems according to the present invention can comprise many different features as described below. For example, the edging in different embodiments can comprise an integral drip irrigation tube that can be at different heights on the edging, such as at the top of the edging or near a midpoint of the edging. The systems according to the present invention can also include different embodiments of decorative or cosmetic caps to give the edging different looks that can be esthetically desirable. These and other aspects and advantages of the invention will become apparent from the following detailed description and the accompanying drawings which illustrate by way of example in the features of the invention.

### BRIEF DESCRIPTION OF THE DRAWINGS

FIG. 1 is a perspective view of one embodiment of a landscaping edge and weed barrier irrigation system according to the present invention;

FIG. 2 is a perspective exploded view of the system shown in FIG. 1;

FIG. 3 is an exploded view of the edging, weed barrier and interconnects used in the system shown in FIG. 1;

FIG. 4 is a perspective of one embodiment of the weed barrier system and interconnects according to the present invention;

FIG. 5 is a plan view of a portion of the weed barrier shown in FIG. 4;

FIG. 6 is a perspective view of one embodiment of a landscaping edge according to the present invention;

FIG. 7 is a sectional view of the landscaping edge in FIG. 6, taken along section lines 7-7;

FIG. 8 is a perspective view of another embodiment of a landscaping edge unit according to the present invention;

FIG. 9 is a sectional view of the landscaping edge unit in FIG. 8 taken along section lines 9-9;

FIG. 10 is perspective view of one embodiment of a landscape edge unit cosmetic cap according to the present invention;

FIG. 11 is a perspective view of another embodiment of a landscape edge unit cosmetic cap according to the present invention;

FIG. 12 is a perspective view of one embodiment of landscaping edge and weed barrier irrigation system according to the present invention having a cosmetic cap;

FIG. 13 is sectional view of the landscape system in FIG. 12 taken along section lines 12-12; and

FIG. 14 is a perspective view of another embodiment of landscaping edge and weed barrier irrigation system according to the present invention having a cosmetic cap.

### DETAILED DESCRIPTION OF THE INVENTION

The present invention is directed to landscaping edge and weed barrier irrigation systems that saves time, increases watering efficiency, provides landscaping flexibility, and that save on gardening practices. Water-conservative gardens require significantly less water than traditional lawns and gardens, which can result in lower water bills and less strain on local water resources. Reduced water usage, lower maintenance requirements and government rebates are incentives for water-conservative gardens.

The present invention is directed to a convenient and efficient watering system for landscaping, with the watering system integrated in landscape barrier strips and weed barrier systems. The barrier strips can define an edge to a gardening or landscape area. In some embodiments, the watering system can comprise an irrigation drip system that can be integrated into a synthetic weed barrier. A water tube can be incased in or integral to the barrier strips as a versatile design element that combines both form and function. This invention creates a watering system without the need to install an underground sprinkler system.

The landscape edging can be attached to an existing water system and can have an edge tube that can be accessed with connectors that can be attached to barrier tubes installed within the weed barriers. The barrier tubes in the weed barriers can comprise a water tubing grid that can be accessed to transport water from the edge tube to the desired landscape area and plants. Organic weed barriers like wood chips or decorative rock can then be placed over the weed barrier covering the synthetic weed barrier and barrier tubing grid system. In some embodiments, portions of the weed barrier system can be modular and capable of interconnection with other portions of a weed barrier system to change the size of the overall weed barrier system to meet the size of the particular landscaping area.

Different embodiments can be arranged in many different ways to provide the advantages discussed above and can also provide additional inventive features. In some embodiments, landscape barrier strips can comprise an integral irrigation edge tube that allows for distribution of water along the edging that can then be distributed to the barrier tubing grid in the synthetic weed barrier. In different embodiments, the integral edge tube can be at different heights on the landscape edging, such as at the top of the edging or at a midpoint of the height of the edge units. The different embodiments can also comprise different decorative elements such as different cosmetic caps that can be placed over the edging to give the desired look to the edging. These caps can be manufactured from different materials to provide different finishes that mimic different materials, such as stone or wood.

In some embodiments, the tube grid can be provided without a weed barrier such as in those applications where weed control may not be as big a concern, or where a more simplified system is desired. In these embodiments, the tube grid can be attached to and carry water from the edge tube to irrigate the landscaping area as described above.

The present invention is described herein with reference to certain embodiments, but it is understood that the invention can be embodied in many different forms and should not be construed as limited to the embodiments set forth herein. It is further understood that different embodiments can comprise different materials arranged in different ways, and can comprise different features. Different embodiments can also be arranged use for other purposes and in other locations.

It will be understood that when an element is referred to as being “on” or “connected to” another element, it can be directly on, or in contact with the other element or intervening elements may be present. In contrast, when an element is referred to as being “directly on”, or “directly connected to” another element, there are no intervening elements present.

Embodiments of the invention are described herein with reference to view illustrations that are schematic illustrations of an embodiment of the invention. The actual thickness or size of components can be different, and variations from the shapes of the illustrations as a result, for example, of manufacturing techniques and/or tolerances are expected. Embodiments of the invention should not be construed as limited to the particular shapes as illustrated herein but are to include deviations in shapes that result, for example, from manufacturing. A region or element illustrated or described as being generally square or rectangular can have rounded or curved features due to normal manufacturing tolerances. Thus, the features illustrated in the figures are schematic in nature and their shapes are not intended to illustrate the precise shape of a feature of a device and are not intended to limit the scope of the invention.

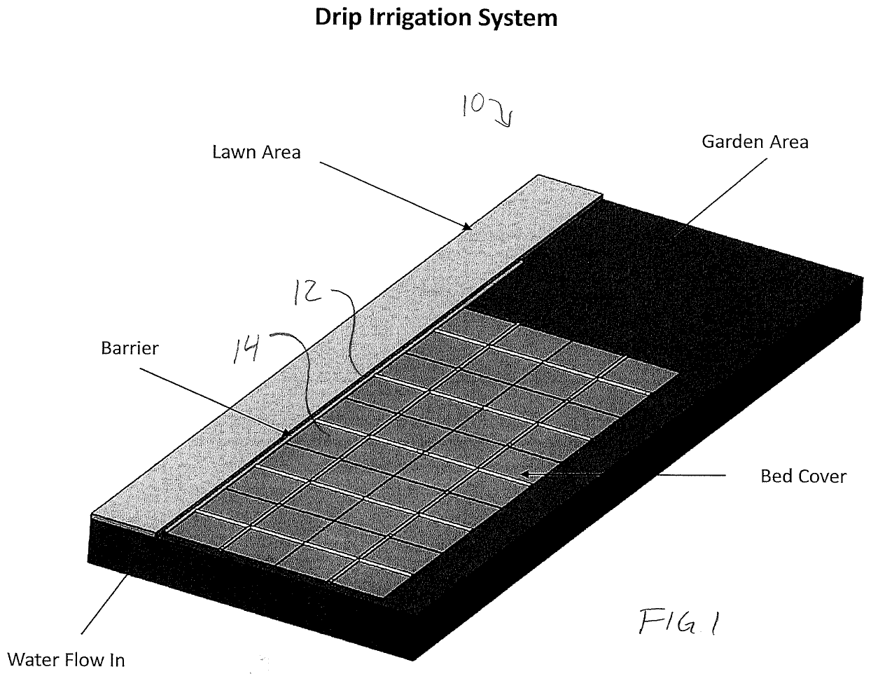

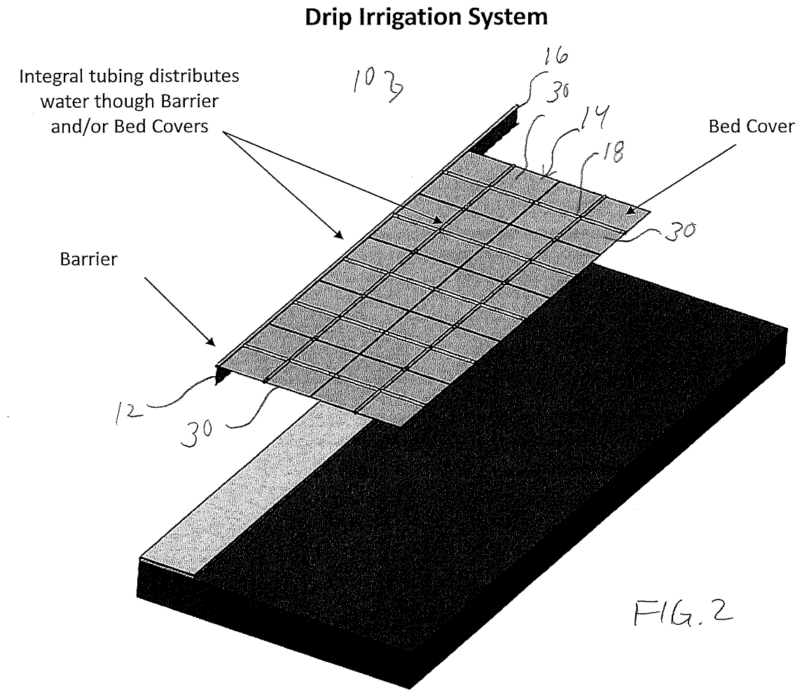

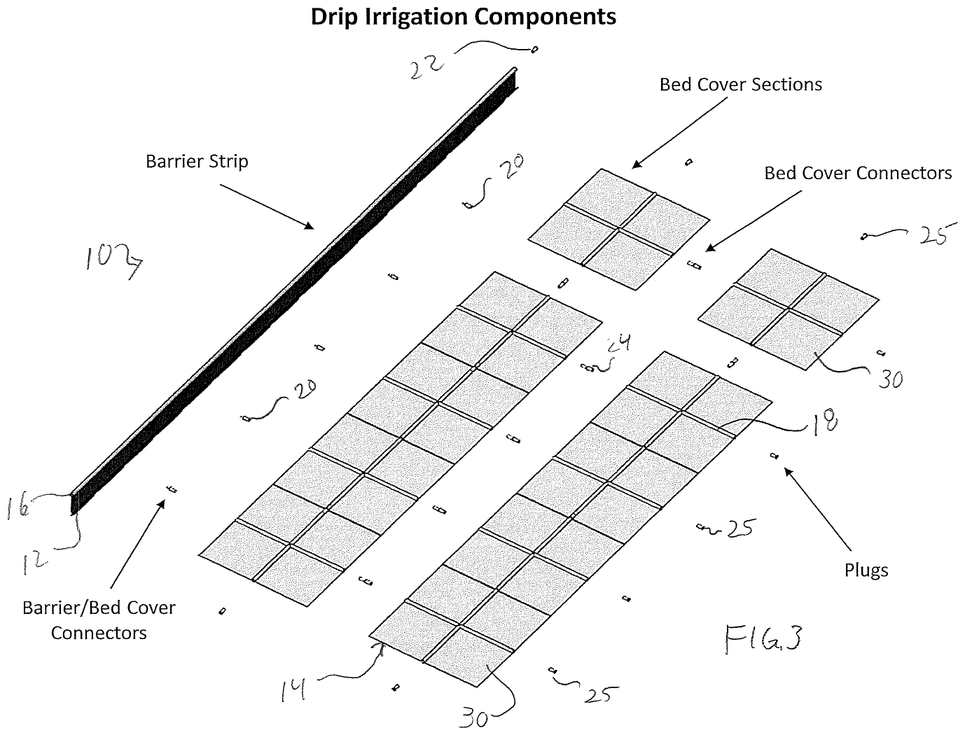

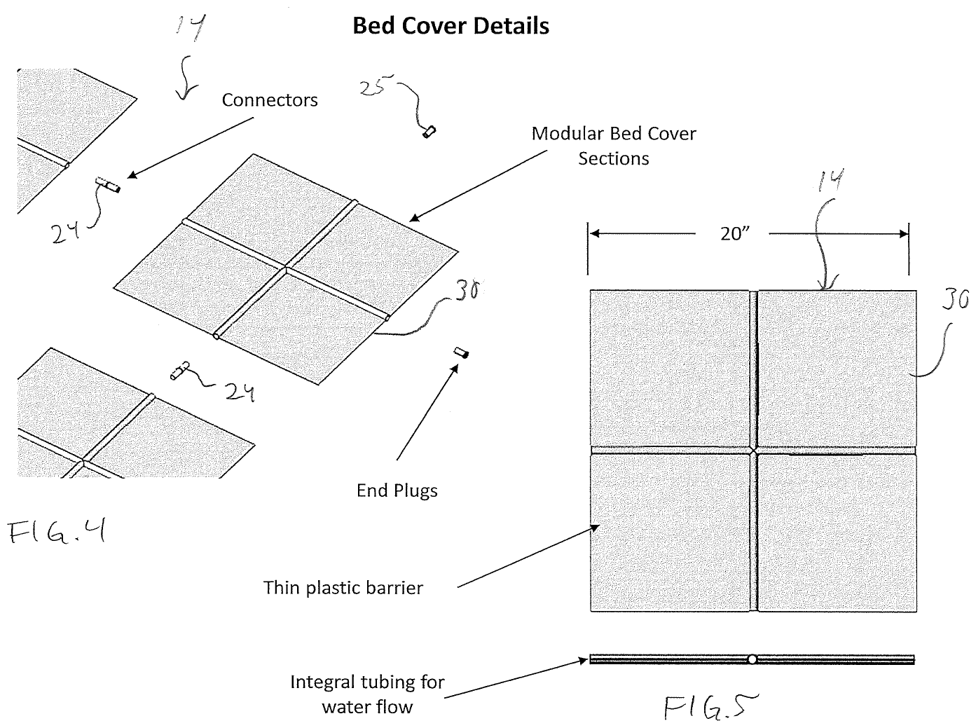

FIGS. 1 through 7 show one embodiment of a modular landscape edging and barrier irrigation system 10 according to the present invention. The systems according to the present invention can comprise modular garden edging or barrier strips 12, and modular weed barrier 14 both having integral irrigation features that allow for irrigation of the landscaping under or adjacent to the weed barrier. The systems according to the present invention can be easy to install, versatile, and enable efficient and flexible garden layouts.

The barrier strips 12 can be interlocking and can be made of durable, weather-resistant materials. The barrier strips have an integral water supply edge tube 16 for distributing water along the barrier strip 12 and to the weed barrier 14. The weed barrier 14 can comprise a barrier tubing grid 18 for distributing water from the edge tube 16 throughout the weed barrier. In some embodiments according to the present invention, one end of hollow tubing connectors 20 to be inserted edge tube 16, with the other end being inserted into a tube in the barrier tubing grid 18. This allows water from the edge tube 16 to flow into the tubes in the barrier tube grid 18, and the tubes in the barrier tube grid 18 can have holes along their length so that water can be distributed to throughout the weed barrier 14. Strip connectors 22 can be included to join the edge units end-to-end or at angles to create straight or curved borders. Weed barrier connectors 24 can be included to connect portions of the weed barrier 14 and to allow water to flow between portions of the barrier tube grid 18. End caps 25 can also be included to cap the desired ones of the tubes in the grid 18. Strip anchors can be included that secure the strip barriers units in place. This modular design allows for use of the system 10 with customizable garden shapes and sizes and with the system 10 on top or near the surface of the landscaping area. This allows easy access to expand or redesign of a watering system.

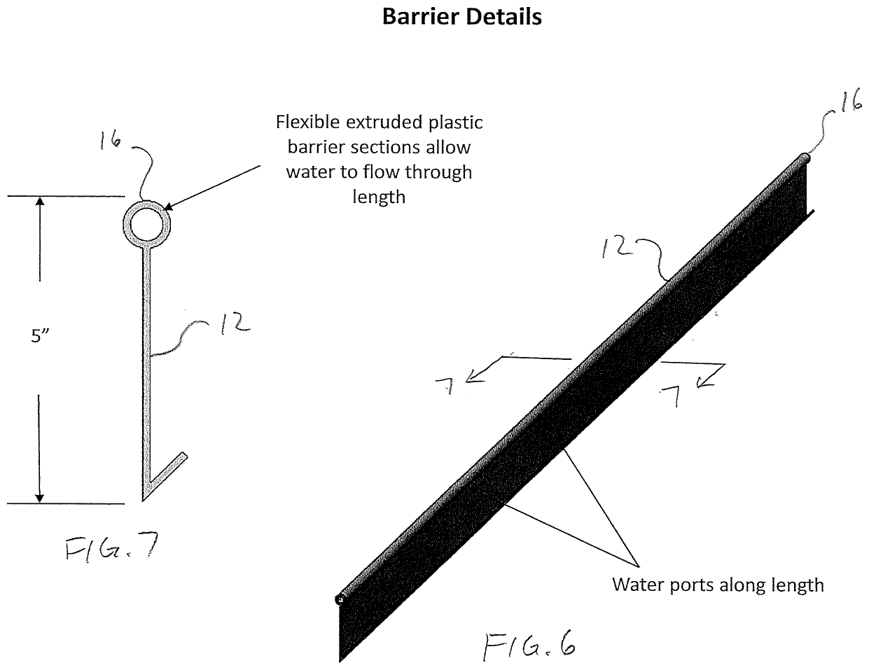

As best shown in FIGS. 6 and 7 the barrier strips 12 can comprise extrusion molded units made of materials such as UV stabilized polypropylene, polyethylene, or an equivalent polymer. The barrier strips 12 can have different heights and lengths, with an exemplary edge units comprising 4-6 inch high vertical slats and can have gaps in between. The barrier strips 12 can be different lengths such as 12-24-36 inches long. These sizes are only examples used in some embodiments, and it is understood that other embodiments can have different sizes.

As described above, each of the barrier strips 12 comprise an integral edge tube 16 to allow water flow. Each barrier strips 12 and its edge tube 16 can easily be attached to an adjacent barrier strip 12 and its edge tube by using strip connectors described below. The outer surface of the edge tube 16 can be exposed so that it can be accessed to allow access to the water passing through the edge tube 16. In some embodiments, the access holes can be formed in the edge tube 16 at the desired locations for these access/connection points can be formed during manufacturing of the barrier strips 12. In other embodiments, the holes can be formed by the installer during installation of the barrier strips 12, with the holes formed using known methods and tools such as those used in installation of drip irrigation systems.

Strip connectors 22 can also be included to connect adjacent edge units together. These connectors can be many different shapes and sizes with some embodiments being approximately 2 inches long with sockets on both sides sized to fit into the irrigation line tubes in the edge units to join multiple pieces in a straight or angled line. The strip connectors can be hollow to allow water to flow between edge tube 16 in the different barrier strips 12. In some embodiments, one strip connector 22 can be used to attach the tubes in adjacent barrier strips 12.

As mentioned above, strip anchors can also be included to anchor the barrier strips 12 in the desired location. In some embodiments, these anchors can comprise pegs made of a ridged material such as a metal or plastic, and the pegs cam be different lengths, such as in the range of 6-12 inches long. The anchors can be sized to fit through holes in the barrier strips 12 to secure them into the ground to prevent lateral movement.

The barrier strips 12 can also comprise other features that allow for their use in different landscaping applications. Angled or corner strip connectors can be provided at different angles, such as 45, 60 or 90 degrees that allow for interconnection of the edge units at different angles or corners, such as 45, 60 or 90 degrees. It is understood that in other embodiments, angle or corner strip connectors can be provided at many other angles. Strip end caps can also be included that can comprise solid end pieces that can have many different shapes, but comprise a portion that fits into and plug the end edge tubing. These can be used at the end of the last barrier strip 12 or can be used where it is desirable not to have water pass between adjacent barrier strips.

As described above, drip irrigation is a method of watering plants by supplying water slowly and directly to the roots using a network of valves, pipes, tubing and emitters. Compared to traditional irrigation methods like flood or sprinkler irrigation, drip irrigation is more efficient as it reduces water loss due to runoff, evaporation, and overspray. Drip irrigation can deliver water and nutrients directly to the plant's roots zone ensuring maximum absorption.

Embodiments of the present invention comprise a drip irrigation system that can be integral to the barrier strips 12 and weed barriers 14 to provide a novel drip irrigation system designed for efficient and customizable watering of plants. In some embodiments, the drip irrigation system comprises barrier tubing grid 18 embedded in a weed barrier with the barrier tubing grid 18 connected to a water source running through the edge tube 16. barrier tubing grid 18 can comprise multiple flexible drip lines with emission devices/drippers spaced at regular intervals. The barrier tubing grid 18 is arranged in the weed barrier 28 in a grid pattern and the water emission devices discharge water slowly at the root zone of the plants. This system allows targeted irrigation for specific plant areas and needs, while the weed barrier keeps the growth of weeds at a minimum.

As mentioned above, water emission devices/drippers can be included on the tubes barrier tubing grid and spaced at regular intervals for each zone, with the emission devices/drippers carrying water that spreads to the plant's root zones. The emission devices/drippers can be built into the tubes of the barrier tubing grid 18, or can be attached at the desired location and can comprise low volume emitters that discharge water slowly at the required flow rate and wet a limited soil area around the plant. Varied flow rates can be used such as 2-20 liters/hour depending on the particular plant water needs, and different flow rate devices/drippers can be used along the length of the supply pipe or drip line.

In some embodiments, barrier tubing grid 18 can be connected to the main water source like a tap, pump, or reservoir to the control unit. In other embodiments, barrier tubing grid 18 can be connected to the edge tube 16 as described above. The barrier tubing grid 18 and drippers distribute water from the main line or edge tube 16 to the different irrigation zones. The drip irrigation system according to the present invention provides a customizable way to easily add plants to the watering system. The slow and targeted discharge reduces runoff, and the weed barrier also helps with evaporation maximizing water use efficiency.

As discussed above, weed growth is a common and persistent problem in gardens and landscaped areas. Plastic weed barriers are often used to suppress weed growth while allowing water and air to permeate. However, plastic sheeting is often not durable and easily degrades due to environmental factors.

Embodiments of the present invention provide an improved weed barrier 14 made of robust materials for long-lasting weed control. Some embodiments of the weed barrier system according to the present invention can comprise reinforced cellulose fiber sheets derived from plant sources that degrade slowly over time. Some embodiments of the barrier system can be constructed from a high-density polyethylene (HDPE) polymer fabric, chosen for its durability, UV resistance, and environmental stability. The fabric is woven in a manner that balances strength and porosity. The weave pattern also ensures a tight structure that prevents weed penetration.

The sheets can be many different thicknesses such as 1-10 mm thick. The fiber sheets can be coated with a biodegradable starch-based resin on both sides which enhances durability and water resistance while maintaining permeability. An of array pores created during manufacturing allows water and gas exchange. The robust weed barrier system prevents light penetration and physically obstructs weed growth for extended periods.

In some embodiments of the system according to the present invention, the weed barrier 14 can be modular and can comprise a plurality of weed barrier sheets 30 that can be interconnected at the tubes in barrier tubing grid 18 the form the overall weed barrier. The sheets 30 can be the same or different sizes and can be made of different materials such as the cellulose described above, and the sheets are durable enough for ground installation. Each of the sheets 30 can comprise a biodegradable thermoplastic resin that can be made from starch polymers and plasticizers like glycerol. The resin can be applied to both surfaces or only one surface of the fiber sheets. In some embodiments, micro-perforations can be formed in each the sheets in a random or orderly pattern to allow permeability for air, water and nutrients to pass through, while still allow for the sheets 30 to minimize weed growth. The perforations can be created during the extrusion process using specialized dies.

The cellulose fiber material used in the weed barrier 28 can provide tensile strength while the starch resin coating imparts tear, puncture and water resistance. The pore array facilitates air and water exchange preventing accumulation of moisture. The opaque barrier blocks light inhibiting weed seed germination. The durable material degrades slowly preventing weed growth for 2-5 years, and provides an eco-friendly and long-lasting weed control solution.

The weed barriers 14 according to the present invention address the challenges of weed management by combining durability, permeability, and weed-suppressing properties. The barrier 14 material effectively inhibits weed growth while allowing water, air, and nutrients to permeate, creating an optimal environment for desired plants.

The weed barrier 14 can be provided in various widths and lengths to accommodate different application requirements. It can be installed by laying it directly onto prepared soil, secured with stakes or pins. The barrier can also be customized with planting holes aligned with desired plant spacing. The synthetic barrier's chemical repellent and tight weave pattern work in tandem to significantly reduce weed growth. The barrier's permeability ensures optimal water, nutrient, and oxygen flow to support healthy plant growth.

The systems according to the present invention are suitable for agriculture, landscaping, and gardening purposes, adapting to various plant types and environments. The synthetic weed barrier 14 described in this patent application offers a novel approach to weed management, addressing the limitations of existing solutions. Its innovative combination of materials, permeability, and repellent treatment provides a comprehensive solution for weed control while supporting desirable plant growth. The barrier's versatility, durability, and environmental responsibility make it a valuable tool for a wide range of applications.

The systems 10 can be installed in many different ways. In some embodiments the weed barrier with tubes embedded can comprise modular sheets that are unrolled and placed on prepared ground for the gardening or landscaping area. The barrier strips 12 laid out around the garden perimeter and connectors installed to join adjacent barrier strips 12. Excess portions of the barrier strips 12 trimmed. The barrier strips 12 can be interconnected to provide the desired length and are secured in place as described above. Anchors 24 are driven through the barrier strips 12 into the ground using a device such as a mallet. Corner units and end caps can be installed to finish the edges. Drip connectors can be used to interconnect the drip lines from one modular sheet to another to form the overall weed barrier for the landscape area. At one edge, the drip lines barrier tube grid 18 edge tube in the barrier strips 12 so that water can be supplied from the barrier strips to the barrier tube grid 18. Drip caps are used at the end of the drip line on the last in line of the modular sheets to plug the end of the drip lines. Mulch, decorative stones or other materials can be placed on the weed barrier as desired.

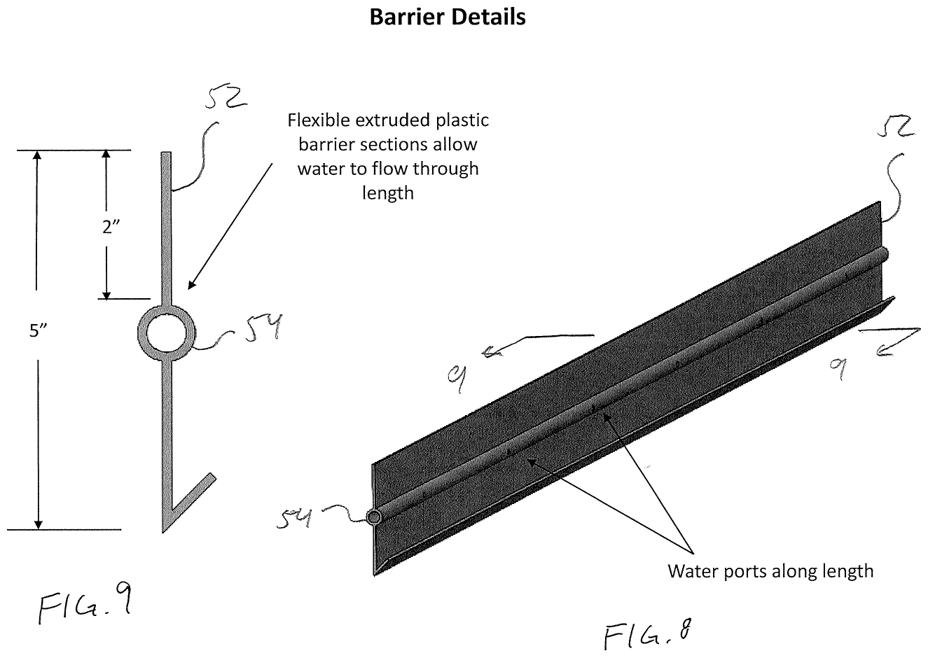

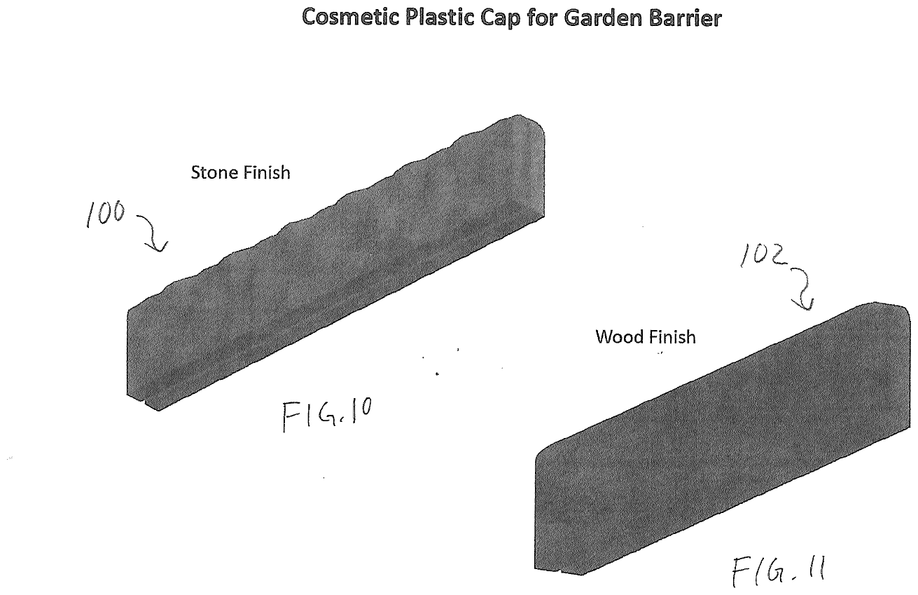

FIGS. 8 and 9 show another embodiment of garden/landscaping barrier strip 52 according to the present inventions that is similar to the barrier strip described above and can be similarly shaped and sized. barrier strip 52 can also be installed at similar angles with anchors as described above and can also work in the same way with the weed barriers as described above. In this embodiment, the edge tube 54 tube is at a mid-height of the edge unit, instead of at the top as shown in the embodiment above. In the embodiment shown, the tube 54 is 2 inches from the top of a 5-inch edge unit, but it understood that this is only one example of a mid-point location in different embodiments.

Having the tube 54 at a midpoint of the barrier strip 52 can allow for the tube 54 to be more closely located at the height of the soil in the landscape area when the barrier strip 52 is installed. The portion of the barrier strip 52 above the tube can be above the surface of the landscaping and the portion below the tube can be in the soil of the landscaping area to anchor the edge unit. This can allow for connection from the edge tube 54 to the barrier tube grid in the weed barrier at the same level as the weed barrier. Ground cover material can be added over the weed barrier systems as described above and the connection between the barrier strip 52 and weed barrier system can be covered by the ground cover material.

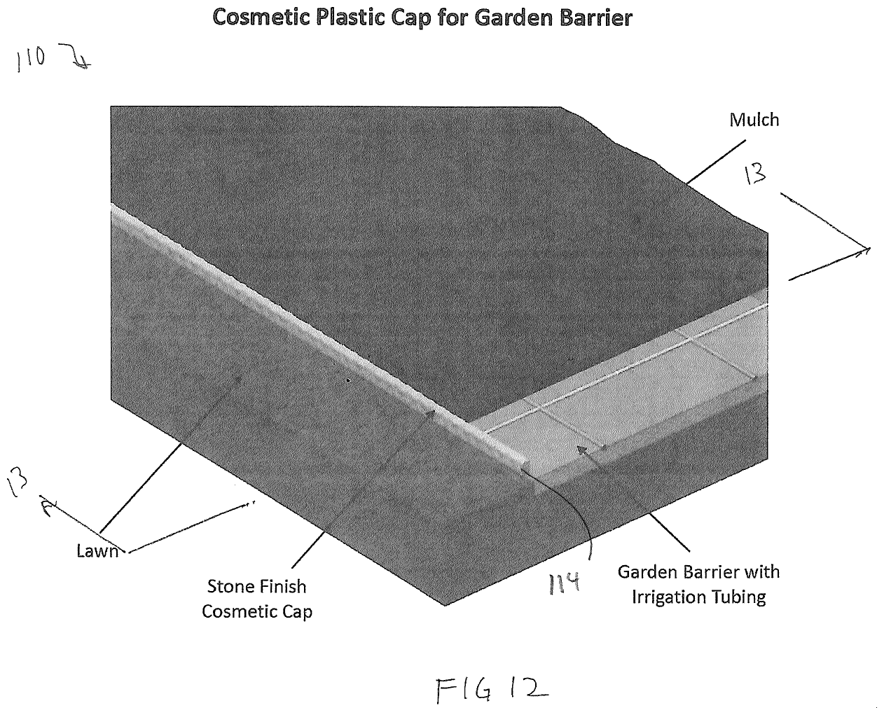

In different embodiments, the present invention can comprise many different features to modify or enhance the performance of the system. FIGS. 10 shows one embodiment of a decorative or cosmetic cap 100 according to the present invention that can be mounted to or affixed to the barrier strip to give the desired decorative look to the system. FIG. 11 shows another embodiment of a cosmetic cap 102 according to the present invention. The caps 100, 102 can comprise different martials such as different plastics and can be flexible or cuttable to match the shape of the edge units bordering the landscaping area. The caps 100, 102 can have different colors and finishes to mimic different materials, with the cap 100 shown in FIG. 10 mimicking stone and the cap 102 shown in FIG. 11 mimicking wood.

In each embodiment, the decorative caps 100, 102 have an internal slot sized to fit closely over the top portion of the barrier strips and can be connected to the barrier strips using different materials or features. In some embodiments, a bonding material such as glue can be used to mount the cap to the barrier strips, while other embodiments can comprise features to allow for the end caps to be press fit to the barrier strips. The end caps 100, 102 can abut one another on the barrier strips to give the appearance of a continuous end cap. The cosmetic caps 100, 102 as shown are particularly applicable to use with edge units having a midpoint tube as shown in FIGS. 10 and 11, with the caps 100, 102 mounted to the portion of the edge unit above the edge tube.

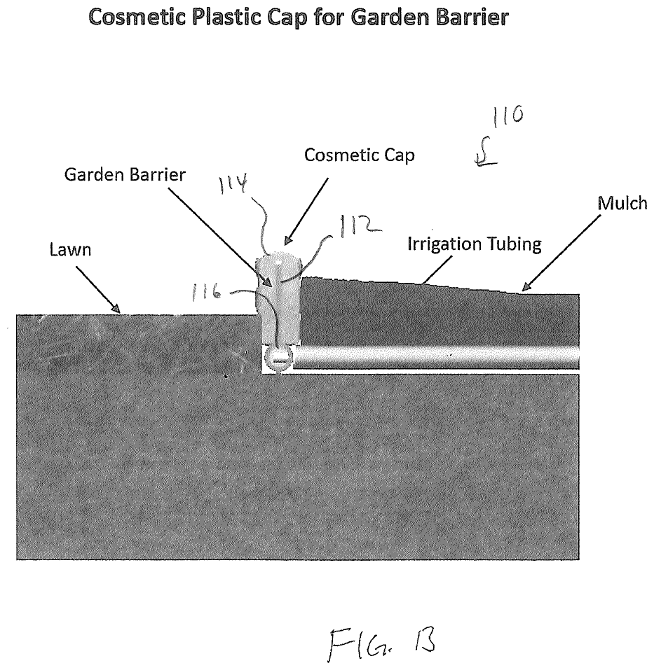

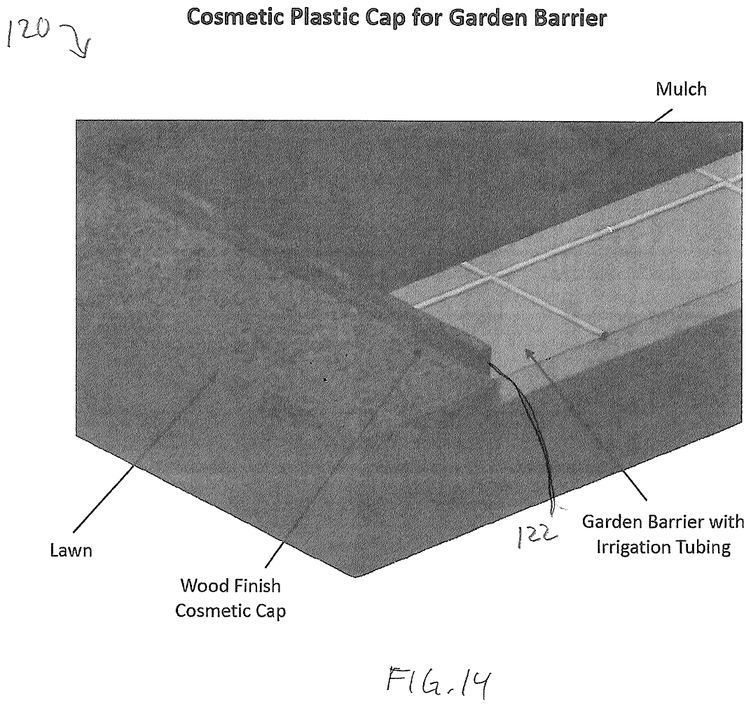

FIGS. 12 and 13 show another embodiment of a modular landscape edging and barrier irrigation system 110 according to the present invention. In this embodiment, the barrier strips 112 have a cosmetic cap 114 that mimics stone. The remainder of the system 110 has features similar to those described above, including connection to and use with the weed barrier systems as described above. This arrangement still allows for access to the edge tube 116 below the cap 114 as best shown in FIG. 13 for connection to the barrier tube grid in the weed barrier system. The ground cover (or mulch) can then be placed over the weed barrier irrigation system as described above and can cover the lower edge of the cap, covering the connection point between the edge tube 116 and the weed barrier system. As shown in FIG. 13, the opposite lower edge of the cap can also be below the surface of the material or vegetation, such as below the lawn as shown.

The different embodiments of cosmetic caps can be installed in the same or similar manner as the cap shown in FIG. 13. For example, FIG. 14 shows another embodiment of modular landscape edging and barrier irrigation system 120 according to the present invention using a cap 122 made of a material and having a finish that mimics wood. The cap 122 can be mounted on barrier strips and can operate in a similar manner to the system as shown in FIG. 13 and described above.

It is understood that different cosmetic caps can be arranged in different ways according to the present invention. For example, in some embodiments the caps can be shaped and sized to work with and be mounted to edge units having an integral tube at or closer to the top.

The advanced drip irrigation system described herein represents a significant advancement in the field of irrigation planning. The system provides flexibility and reliability in weed control and irrigation, while also providing an efficient irrigation system. The systems according to the present invention ensure that plants receive the precise amount of water they need, while minimizing waste and optimizing growth. The systems provide for a reduction of weeds while also providing flexibility for future designs.

It is understood that many different mechanisms and arrangements can be used in the different systems according to the present invention. Although the present invention has been described in detail with reference to certain configurations thereof, other versions are possible. Therefore, the spirit and scope of the invention should not be limited to the versions described above.

I claim:

1. A landscape edging and barrier irrigation system, comprising:
a barrier strip having an integral edge tube capable of carrying a flow of water;
a weed barrier comprising a barrier sheet with a barrier tube grid capable of carrying a flow of water, wherein at least a portion of water flowing through said edge tube flows through said barrier tube grid, and wherein said barrier tube grid comprises one or more grid openings to allow water to flow from said barrier tube grid.

2. The system of claim 1, wherein said one or more openings allow water to flow from said barrier tube grid to below said weed barrier.

3. The system of claim 1, wherein said weed barrier comprises a plurality of interconnected weed barrier sheets.

4. The system of claim 1, wherein said barrier strip comprises a plurality of interconnected barrier strips.

5. The system of claim 1, wherein said barrier tube grid is connected to said edge tube.

6. The system of claim 1, wherein said edge tube is at a top surface of the barrier strip.

7. The system of claim 1, wherein said edge tube is below a top surface of said barrier strip.

8. The system of claim 1, wherein said edge tube is substantially halfway between a bottom and top surface of said barrier strip.

9. The system of claim 1, wherein said one or more grid openings comprise drip irrigation openings.

10. The system of claim 1, wherein said one or more grid openings emission drippers.

11. A landscape edging and barrier irrigation system, comprising:
a barrier strip having an integral edge tube capable of carrying a flow of water;
a tube grid connected to said edge tube such that water flowing though said edge tube flows into said tube grid, and wherein said tube grid comprises drip irrigation openings.

12. The system of claim 11, further comprising a weed barrier integral to said tube grid.

13. The system of claim 12, wherein said weed barrier comprises a plurality of weed barrier sheets, each having one of a plurality of integral tube portions, wherein said weed barrier sheets and said integral tube portions are interconnected to form said weed barrier sheet with said integral tube grid.

14. The system of claim 11, wherein said barrier strip comprises a plurality of interconnected barrier strips.

15. The system of claim 11, wherein said edge tube is at a top surface of the barrier strip.

16. The system of claim 11, wherein said edge tube is below a top surface of said barrier strip.

17. The system of claim 11, wherein said edge tube is substantially halfway between a bottom and top surface of said barrier strip.

18. A landscape edging and barrier irrigation system, comprising:
a barrier strip surrounding a landscaped area, said barrier strip capable of carrying a first flow of water down its length;
a weed barrier connected to said barrier strip and arranged on said landscaped area, wherein said weed barrier is capable of carrying a second flow of water and depositing at least some of said second flow of water on said landscaped area, wherein said second flow of water comprises at least a portion of said first flow of water.

19. The system of claim 18, wherein said barrier strip comprises an edge tube for carrying said first flow of water.

20. The system of claim 18, comprising a barrier tube grid for carrying said second flow of water.
